(19) United States
(12) Patent Application Publication
(10) Pub. No.: US 2005/0054251 A1
(43) Pub. Date: Mar. 10, 2005

(54) Undergarments containing active substances

(75) Inventors: Rainer Kropke, Schenefeld (DE); Andreas Schafer, Hamburg (DE)

Correspondence Address: GREENBLUM & BERNSTEIN, P.L.C., 1950 ROLAND CLARKE PLACE, RESTON, VA, 20191, US

(73) Assignee: BEIERSDORF AG, Hamburg (DE)

(21) Appl. No.: 10/864,481

(22) Filed: Jun. 10, 2004

Related U.S. Application Data
(63) Continuation of application No. PCT/EP02/14138, filed on Dec. 12, 2002.

(30) Foreign Application Priority Data
Dec. 12, 2001 (DE) 101 60 888.8

(51) Int. Cl. B32B 27/12; B32B 27/04; B32B 5/02

(52) U.S. Cl. 442/123

(57) ABSTRACT

A garment which comprises cosmetic and/or dermatological active ingredients.

### CROSS-REFERENCE TO RELATED APPLICATIONS

The present application is a continuation of International Application No. PCT/EP02/14138, filed Dec. 12, 2002, the entire disclosure whereof is expressly incorporated by reference herein, which claims priority under 35 U.S.C. § 119 of German Patent Application No. 101 60 888.8, filed Dec. 12, 2001.

### BACKGROUND OF THE INVENTION

1. Field of the Invention

The present invention relates to underwear which is loaded with cosmetic and/or dermatological active ingredients.

2. Discussion of Background Information

Cosmetic and/or dermatological active ingredients are often used in order to help people attain a more pleasant sensory overall impression. In order to improve the odor impression of the user, it may be attempted to use perfume substances to cover up nasty body smells, or to prevent the formation of these smells, for example, through the use of antiperspirants or disinfecting substances. In most cases, such preparations are administered in the form of sprays, thin-liquid preparations (deodorant roll-ons) or stick-like preparations (sticks).

Also, in order to improve the optical impression and, for example, to avoid disfigurements caused by illness or aging (e.g. wrinkles or lines), and to reduce or eliminate color unevennesses in the skin, there are available a large number of liquid to highly viscous preparations, mostly ointments or lotions.

These products are in most cases applied directly to the skin. However, the sensation on the skin is often greasy and unpleasant. In addition, when worn under underwear, the latter becomes soiled with the usually fat-containing preparations.

Plasters, patches, bandages and masks loaded with active ingredients are also known. Their disadvantage is that they can in most cases only be used once, which is not acceptable for reasons of environmental protection. In addition, the wearing of such active ingredient carriers is often uncomfortable and unaesthetic.

It would, therefore, be desirable to overcome or to reduce the disadvantages of the prior art and to develop new application forms for cosmetic and/or dermatological active ingredients.

### SUMMARY OF THE INVENTION

The present invention provides a garment which comprises one or more active ingredients from the group of cosmetic and dermatological active ingredients.

In one aspect, the garment may be a shirt, a T-shirt, a bra, underpants, a sleep suit, a bustier, a suspender belt, stockings and a panty hose.

In another aspect, the garment may comprise a natural fiber, a synthetic fiber, leather and/or latex. For example, the garment may comprise a natural fiber.

In yet another aspect, the garment may comprise lambswool, cashmere wool, silk, cotton, linen, jute, hemp and/or sisal. For example, the garment may comprise cotton.

In another aspect, the garment may comprise a synthetic fiber. For example, the garment may comprise a polyester and/or a polyamide.

In another aspect of the garment of the present invention, the garment may further comprise a cyclodextrin and/or a cyclodextrin derivative, preferably β-cyclodextrin and/or a β-cyclodextrin derivative. The cyclodextrin and/or cyclodextrin derivative may be immobilized on at least a part of the garment.

In a preferred aspect, the garment may comprise a cellulose-containing fiber having a β-cyclodextrin derivative bonded thereto. This β-cyclodextrin derivative may, for example, comprise monochlorotriazinyl-β-cyclodextrin.

In another preferred aspect, the garment may comprise a synthetic fiber having a hydrophobicized cyclodextrin derivative attached thereto.

In another aspect of the garment of the present invention, the garment may provide a controlled and/or a delayed release of the one or more active ingredients.

In another aspect, the one or more active ingredients may comprise a pheromone, an aphrodisiac, a bleach, a self-tanning agent, a repellent, a perfume substance, an active ingredient for the prophylaxis or treatment of inflammatory skin conditions, an active ingredient for protecting sensitive and/or dry skin, an antiwrinkle agent and/or an agent for treating cellulite.

In yet another aspect, the one or more active ingredients may comprise an agent for treating a condition selected from atopic eczema, seborrheic eczema, polymorphous photodermatosis, psoriasis, vitiligo, a wound healing disorder, itching, sensitive or irritated skin, photoinduced skin damage and UV-induced immunosuppression, changes in desquamation, changes in normal fibroblast and keratinocyte proliferation, changes in normal fibroblast and keratinocyte differentiation, and deficient sensitive or hypoactive conditions of skin appendages.

The present invention also provides a process for the manufacture of a garment which comprises one or more cosmetic and/or dermatological active ingredients. This process comprises contacting the garment with at least one of said active ingredients in a washing operation and/or a drying operation.

In one aspect of this process, the manufacture may comprise a regeneration of the garment with the one or more active ingredients.

In another aspect, the process may further comprise the initial contacting of the garment with one or more cyclodextrins. For example, the one or more cyclodextrins may be immobilized on the garment.

In yet another aspect of the process, the garment may be a shirt, a T-shirt, a bra, underpants, a sleep suit, a bustier, a suspender belt, stockings or a panty hose.

In a still further aspect of the process, the one or more active ingredients may comprise at least one of a pheromone, an aphrodisiac, a bleach, a self-tanning agent, a repellent, a perfume substance, an active ingredient for a prophylaxis or treatment of inflammatory skin conditions, an active ingredient for protecting sensitive or dry skin, an antiwrinkle agent and an agent for treating cellulite.

The present invention further provides a method of applying a cosmetic or dermatological active ingredient to skin. This method comprises wearing an garment which comprises the active ingredient in contact with at least a part of the skin.

In one aspect of the method, the garment may comprise a shirt, a T-shirt, a bra, underpants, a sleep suit, a bustier, a suspender belt, stockings and a panty hose. In another aspect, the garment may comprise a natural fiber, a synthetic fiber, leather and/or latex.

In yet another aspect, the garment may further comprise a cyclodextrin and/or a cyclodextrin derivative which is immobilized on at least a part of the garment.

In a still further aspect, the active ingredient may comprise at least one of a pheromone, an aphrodisiac, a bleach, a self-tanning agent, a repellent, a perfume substance, an active ingredient for a prophylaxis or treatment of inflammatory skin conditions, an active ingredient for protecting sensitive or dry skin, an antiwrinkle agent and an agent for treating cellulite.

In another aspect of the method, the skin may be continuously treated with the active ingredient.

In accordance with the invention, the terms “garment” or “underwear” are to be understood as meaning items of laundry which are mostly in close contact with the skin. In accordance with the invention, shirts, T-shirts, bras, underpants, sleep suits, bustiers, suspender belts, stockings and/or panty hose are particularly advantageous. Gloves, head coverings (e.g. baseball caps, hats), diapers, bathing trunks, swimming costumes and bikinis can also be used advantageously according to the invention.

According to the invention, the textiles can advantageously consist of natural and/or synthetic fibers. Of particular advantage here are lambswool, cashmere wool, silk, cotton, linen, jute, hemp, sisal, polyester and polyamide. All sorts of natural leather, artificial leather and latex are also textiles which are advantageous according to the invention.

According to the invention, textiles on which cyclodextrin are immobilized are advantageous. These allow the controlled and delayed release of active ingredients while wearing the underwear. Cyclodextrin is understood here as meaning any of α-, β- and γ-cyclodextrin, and also their derivatives provided completely or partially with ether and/or ester groups.

Preferred cyclodextrins are β-cyclodextrin and β-cyclodextrin derivatives. Thus, for example, the monochlorotriazinyl-β-cyclodextrin sold by Wacker (Burghausen, Germany) under the trade name Beta W7 MCT is able, in an excellent manner, to attach, by means of covalent bonding, to cellulose-containing fibers, such as cotton fibers or cotton-containing blends. In addition, hydrophobicized cyclodextrin derivatives, e.g. obtainable by substitution of cyclodextrins with long-chain hydrophobic groups, can be used for attaching to synthetic fibers under the conditions of established emulsion paint processes.

Cosmetic and/or dermatological active ingredients which may be used in the present invention are, inter alia, pheromones, aphrodisiacs, bleaches, self-tanning agents, repellents, perfume substances, active ingredients for the prophylaxis and/or treatment of inflammatory skin conditions and/or for skin protection in cases of sensitively determined and dry skin (such as, for example, atopic eczema, seborrheic eczema, polymorphous photodermatosis, psoriasis, vitiligo, wound healing disorders, itching, sensitive or irritated skin, photoinduced skin damage and UV-induced immunosuppression, changes in desquamation, changes in normal fibroblast and keratinocyte proliferation, changes in normal fibroblast and keratinocyte differentiation of deficient sensitive or hypoactive skin conditions or deficient sensitive or hypoactive conditions of skin appendages and for reducing the thickness of the skin), and also for the treatment and/or prophylaxis of wrinkles and lines, and also of cellulite is also advantageous according to the invention.

In addition, a process for the preparation and/or regeneration of underwear in which the clean or cleaned underwear is loaded in a separate washing and/or drying operation with the cosmetic and/or dermatological active ingredients is provided by the invention. This process can also be characterized in that the clean or cleaned underwear is loaded firstly with cyclodextrins. This loading can also take place according to the invention by immobilizing the cyclodextrins.

Last but not least, the use of underwear for applying cosmetic and/or dermatological active ingredients to the skin and the use of underwear for the continuous treatment of the skin with cosmetic and/or dermatological active ingredients is advantageous according to the invention.

### DETAILED DESCRIPTION OF THE INVENTION

The example below is intended to illustrate the present invention without limiting it. The quantities given refer to the total weight of the treatment liquid.

The cotton-containing fabric to be treated is immersed into a treatment liquid heated to 50° C. and comprising in each case 0.05% by weight of monochlorotriazinyl-β-cyclodextrin, sodium carbonate and NaOH solution (5% by weight) and left therein for 120 minutes. The fabric is then removed and rinsed several times with cold water.

1. A garment which comprises one or more active ingredients from the group of cosmetic and dermatological active ingredients.

2. The garment of claim 1, wherein the garment comprises at least one of a shirt, a T-shirt, a bra, underpants, a sleep suit, a bustier, a suspender belt, stockings and a panty hose.

3. The garment of claim 1, wherein the garment comprises at least one of a natural fiber, a synthetic fiber, leather and latex.

4. The garment of claim 1, wherein the garment comprises a natural fiber.

5. The garment of claim 4, wherein the garment comprises at least one of lambswool, cashmere wool, silk, cotton, linen, jute, hemp and sisal.

6. The garment of claim 4, wherein the garment comprises cotton.

7. The garment of claim 1, wherein the garment comprises a synthetic fiber.

8. The garment of claim 7, wherein the garment comprises at least one of a polyester and a polyamide.

9. The garment of claim 1, wherein the garment further comprises at least one of a cyclodextrin and a cyclodextrin derivative.

10. The garment of claim 9, wherein the at least one of a cyclodextrin and a cyclodextrin derivative is immobilized on at least a part of the garment.

11. The garment of claim 1, wherein the garment further comprises at least one of a β-cyclodextrin and a β-cyclodextrin derivative.

12. The garment of claim 1, wherein the garment comprises a cellulose-containing fiber having a β-cyclodextrin derivative bonded thereto.

13. The garment of claim 12, wherein the β-cyclodextrin derivative comprises monochlorotriazinyl-β-cyclodextrin.

14. The garment of claim 1, wherein the garment comprises a synthetic fiber having a hydrophobicized cyclodextrin derivative attached thereto.

15. The garment of claim 1, wherein the garment provides at least one of a controlled and a delayed release of the one or more active ingredients.

16. The garment of claim 1, wherein the one or more active ingredients comprise at least one of a pheromone, an aphrodisiac, a bleach, a self-tanning agent, a repellent, a perfume substance, an active ingredient for a prophylaxis or treatment of inflammatory skin conditions, an active ingredient for protecting sensitive or dry skin, an antiwrinkle agent and an agent for treating cellulite.

17. The garment of claim 1, wherein the one or more active ingredients comprise at least one agent for treating a condition selected from atopic eczema, seborrheic eczema, polymorphous photodermatosis, psoriasis, vitiligo, a wound healing disorder, itching, sensitive or irritated skin, photoinduced skin damage and UV-induced immunosuppression, changes in desquamation, changes in normal fibroblast and keratinocyte proliferation, changes in normal fibroblast and keratinocyte differentiation, and deficient sensitive or hypoactive conditions of skin appendages.

18. A process for the manufacture of a garment which comprises one or more active ingredients from the group of cosmetic and dermatological active ingredients, wherein the process comprises contacting the garment with at least one of said active ingredients in at least one of a washing operation and a drying operation.

19. The process of claim 18, wherein the manufacture comprises a regeneration of the garment with the one or more active ingredients.

20. The process of claim 18, wherein the process further comprises initially contacting the garment with one or more cyclodextrins.

21. The process of claim 20, wherein the one or more cyclodextrins are immobilized on the garment.

22. The process of claim 18, wherein the garment comprises at least one of a shirt, a T-shirt, a bra, underpants, a sleep suit, a bustier, a suspender belt, stockings and a panty hose.

23. The process of claim 22, wherein the one or more active ingredients comprise at least one of a pheromone, an aphrodisiac, a bleach, a self-tanning agent, a repellent, a perfume substance, an active ingredient for a prophylaxis or treatment of inflammatory skin conditions, an active ingredient for protecting sensitive or dry skin, an antiwrinkle agent and an agent for treating cellulite.

24. A method of applying a cosmetic or dermatological active ingredient to skin, wherein the method comprises wearing an garment which comprises the active ingredient in contact with at least a part of the skin.

25. The method of claim 24, wherein the garment comprises at least one of a shirt, a T-shirt, a bra, underpants, a sleep suit, a bustier, a suspender belt, stockings and a panty hose.

26. The method of claim 24, wherein the garment comprises at least one of a natural fiber, a synthetic fiber, leather and latex.

27. The method of claim 26, wherein the garment further comprises at least one of a cyclodextrin and a cyclodextrin derivative which is immobilized on at least a part of the garment.

28. The method of claim 27, wherein the active ingredient comprises at least one of a pheromone, an aphrodisiac, a bleach, a self-tanning agent, a repellent, a perfume substance, an active ingredient for a prophylaxis or treatment of inflammatory skin conditions, an active ingredient for protecting sensitive or dry skin, an antiwrinkle agent and an agent for treating cellulite.

29. The method of claim 24, wherein the skin is continuously treated with the active ingredient.
